(19) United States
(12) Patent Application Publication
(10) Pub. No.: US 2026/0084498 A1
(43) Pub. Date: Mar. 26, 2026

(54) IN-VEHICLE SUNSHADE

(71) Applicant: Dongyu He, Shenzhen (CN)

(72) Inventor: Dongyu He, Shenzhen (CN)

(21) Appl. No.: 19/032,852

(22) Filed: Jan. 21, 2025

(30) Foreign Application Priority Data
Sep. 23, 2024 (CN) 202422333295.6

(51) Int. Cl. B60J 1/20

(52) U.S. Cl. CPC B60J 1/2091

(57) ABSTRACT

The present disclosure relates to an in-vehicle sunshade, including an umbrella handle, foldable ribs, and an umbrella fabric. The umbrella handle has a mounting end and a handle end opposite to each other in an axial direction thereof. The handle end is capable of rotating and bending relative to the mounting end to adjust the direction of the handle end. The foldable ribs are connected to the mounting end of the umbrella handle. According to the in-vehicle sunshade provided by the present disclosure, a user can adjust the placement location of the handle end according to positions of a steering wheel and a display in a vehicle. The umbrella handle will not bump against the steering wheel and the display in the vehicle, and the steering wheel and the display will not be damaged, so that the user experience is good.

### CROSS-REFERENCE TO RELATED APPLICATIONS

The application claims priority of Chinese patent application CN2024223332956, filed on Sep. 23, 2024, which is incorporated herein by reference in its entireties.

### TECHNICAL FIELD

The present disclosure relates to the technical field of sunshades, and particularly relates to an in-vehicle sunshade.

### BACKGROUND

When a vehicle is parked outdoors in summer, sunshine will pass through the windshield to irradiate the cabin, resulting in too high temperature in the vehicle and adversely affecting automotive trims. Therefore, a user often needs an in-vehicle sunshade. The in-vehicle sunshade in the prior art is mainly arranged on the inner side of the windshield. During use, the in-vehicle sunshade is paved along a plane of the windshield to prevent sunshine from directly irradiating the cabin. For example, a Chinese patent literature CN216942626U discloses an in-vehicle sunshade, including an umbrella handle, foldable ribs connected to the upper end of the umbrella handle, and an umbrella fabric connected to the top of each of the ribs and folded and spreading with the ribs. However, the umbrella handle of this in-vehicle sunshade easily bumps against the steering wheel or display screen in the vehicle, resulting in damage to the steering wheel or the display screen, so that the user experience is poor.

### SUMMARY

The present disclosure provides an in-vehicle sunshade to solve the problem that the user experience is poor as the umbrella handle of the in-vehicle sunshade easily bumps against the steering wheel or the display screen in the vehicle to damage the steering wheel or the display screen.

To solve the above technical problem, the present disclosure adopts the following technical solution:

An in-vehicle sunshade, including:
an umbrella handle, having a mounting end and a handle end opposite to each other in an axial direction thereof, where the handle end is capable of rotating and bending relative to the mounting end to adjust the direction of the handle end;
foldable ribs, connected to the mounting end of the umbrella handle; and
an umbrella fabric, connected to the top of the ribs and capable of being folded and spreading with the ribs.

Optionally, the handle end comprises a metal hose and a metal rigid tube connected to each other, the metal hose is connected to the mounting end, and the metal hose drives the metal rigid tube to rotate relative to the mounting end.

Optionally, further comprising a connector, a first mounting hole is formed in one end of the mounting end close to the metal hose, a second mounting hole is formed in one end of the metal hose close to the mounting end, and the connector passes through the first mounting hole and the second mounting hole.

Optionally, two first mounting holes are formed, and the two first mounting holes are formed oppositely in a radial direction of the mounting end; and two second mounting holes are formed, and the two second mounting holes are formed oppositely in a radial direction of the metal hose.

Optionally, a plurality of elastically deformable supporting members are arranged at a circumferential edge of the umbrella fabric, an external end of each of the ribs away from the umbrella handle is in limiting fit with the supporting members, and partial structures of the umbrella fabric and the supporting members extend outward relative to the external end.

Optionally, further comprising a plurality of elastic members, wherein the number of the elastic members matches the number of the supporting members, the elastic members are sleeved on an outer side of each of the ribs, and partial structures of the elastic members are accommodated in the supporting members.

Optionally, a length direction of the supporting members is parallel to a length direction of the external end of each of the ribs.

Optionally, a limiting hole is formed between each of the supporting members and the umbrella fabric, and the external end of the rib is accommodated in the limiting hole.

Optionally, the supporting members are enclosed to form a limiting hole, and the external end of each of the ribs is accommodated in the limiting hole.

Optionally, the external end of each of the ribs is in sewing connection to each of the supporting members.

Optionally, the supporting members are leather sheets; or,
the supporting members are rubber sheets; or
the supporting members are plastic sheets.

Optionally, further comprising a covering surface, wherein the covering surface is arranged on one side of the umbrella fabric close to the umbrella handle, and the area of the covering surface is smaller than the area of the umbrella fabric.

Optionally, a reflective coating is arranged on one side of the umbrella fabric facing away from the covering surface, and an ultraviolet-proof coating is arranged on one side of the covering surface facing towards the umbrella fabric.

Optionally, the covering surface and the umbrella fabric both are of quadrilateral structures.

Optionally, the umbrella fabric is provided with a magic tape for fixing the umbrella fabric when the in-vehicle sunshade is in a stored state.

Optionally, the magic tape comprises a binding rope, a male surface of the magic tape, and a female surface of the magic tape, and after the binding rope winds the ribs a circle, the male surface of the magic tape is adhered to the female surface of the magic tape.

Optionally, the umbrella fabric is provided with a folding space.

Optionally, a positioning hole is formed in the middle position of the umbrella fabric, and one end of the mounting end away from the handle end is mounted in the positioning hole.

Optionally, the mounting end is provided with a locking hole; each of the ribs comprises a support rod assembly and a locking structure; the locking structure is sleeved on the umbrella handle and is slidably connected to the umbrella handle; the locking structure is capable of moving relative to the mounting end until the locking structure is clamped in the locking hole; and one end of the support rod assembly is rotationally connected to the end of the mounting end away from the handle end, and the other end of the support rod assembly is rotationally connected to the locking structure.

Optionally, the support rod assembly comprises a first support rod, a second support rod, a third support rod, and a tightening strip; one end of the first support rod is rotationally connected to the locking structure and the other end of the first support rod is connected to the third support rod; and two opposite ends of the second support rod are respectively connected to the first support rod and the end of the mounting end away from the handle end and two opposite ends of the tightening strip are respectively connected to the second support rod and the third support rod.

It can be known from the technical solution that the embodiments of the present disclosure at least have the advantages and positive effects:

The in-vehicle sunshade provided by the present disclosure includes the umbrella handle, the foldable ribs, and the umbrella fabric, where the umbrella handle has the mounting end and the handle end opposite to each other in an axial direction thereof, the handle end is capable of rotating and bending relative to the mounting end to adjust the direction of the handle end; the user can adjust the placement location of the handle end according to positions of the steering wheel and the display in the vehicle. The umbrella handle will not bump against the steering wheel and the display in the vehicle, and the steering wheel and the display will not be damaged, so that the user experience is good.

### BRIEF DESCRIPTION OF THE DRAWINGS

To more clearly illustrate the embodiments of the present disclosure or the technical solutions in the prior art, the accompanying drawings required in the embodiments will be briefly introduced below. It is apparent that the drawings in the following description are only some embodiments of the present disclosure, and for those of ordinary skill in the art, other drawings can also be obtained according to these drawings without making creative efforts.

FIG. 1 is an overall schematic structural diagram of an in-vehicle sunshade in an embodiment of the present disclosure;

FIG. 2 is a schematic diagram of an umbrella handle of the in-vehicle sunshade shown in FIG. 1 in a bent state;

FIG. 3 is a partially enlarged schematic structural diagram of an area A of the in-vehicle sunshade shown in FIG. 2;

FIG. 4 is an exploded schematic structural diagram of the umbrella handle of the in-vehicle sunshade shown in FIG. 1;

FIG. 5 is a partially enlarged schematic structural diagram of an area B of the in-vehicle sunshade shown in FIG. 1; and

FIG. 6 is a partially enlarged schematic structural diagram of an area C of the in-vehicle sunshade shown in FIG. 1.

Reference numerals are illustrated as follows:
10, in-vehicle sunshade;
100, umbrella handle;
110, mounting end;
111, first mounting hole;
112, locking hole;
120, handle end;
121, metal hose;
122, metal rigid tube;
123, second mounting hole;
200, rib;
210, support rod assembly;
211, first support rod;
212, second support rod;
213, third support rod;
214, tightening strip;
220, locking structure;
300, umbrella fabric;
310, supporting member;
320, limiting hole;
330, magic tape;
331, binding rope;
332, male surface of magic tape;
333, female surface of magic tape;
340, folding space;
400, connector;
500, elastic member;
600, covering surface.

### DETAILED DESCRIPTION OF THE EMBODIMENTS

Exemplary embodiments that embody the features and advantages of the present disclosure will be described in detail in the following description. It will be appreciated that the present disclosure may have various changes in different embodiments without departing from the scope of the present disclosure, and that the description and drawings are illustrative in nature and are not intended to limit the present disclosure.

In addition, the terms “first” and “second” are merely used for descriptive purposes and cannot be construed as indicating or implying relative importance or implicitly specifying the number of indicated technical features. Thus, a feature defined with “first” or “second” can explicitly or implicitly include at least one of the features. In the description of the present application, “a plurality of”means two or more, unless expressly specified otherwise.

In the description of the present application, it shall be noted that unless otherwise specified and defined, the terms “mounting”, “connecting” and “connection” shall be understood in a broad sense, for example, “mounting”, “connecting” and “connection” can be either fixed connection or detachable connection or integrated connection; can be either mechanical connection or electric connection; and can be either a direct connection or indirect connection via an intermediation or internal communication of two components. Those of ordinary skill in the art may understand the specific meanings of the foregoing terms in this application according to specific situations.

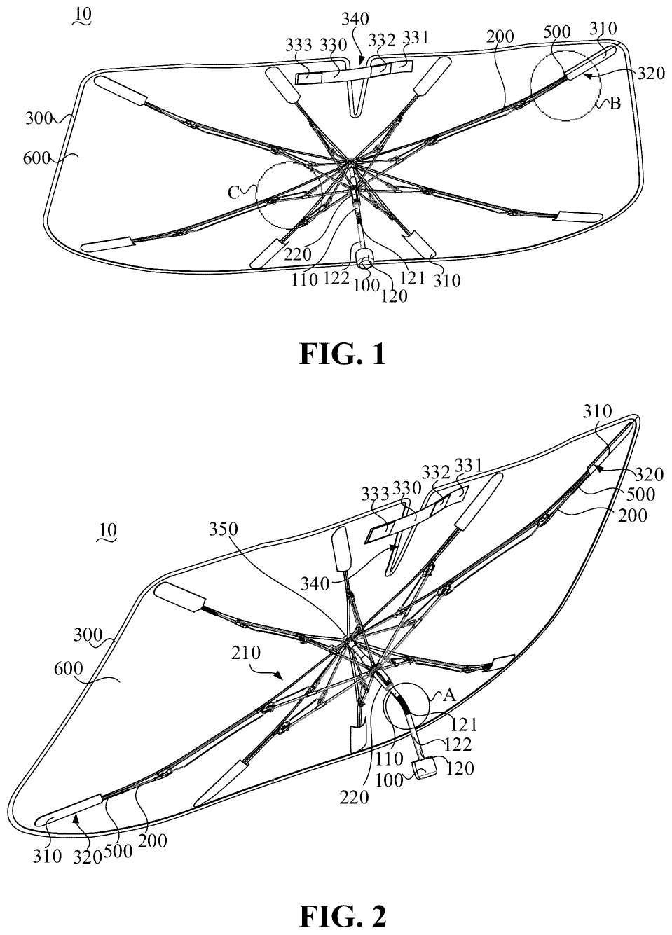

First referring to FIG. 1, the present disclosure provides an in-vehicle sunshade 10, arranged on the inner side of a windshield to reduce sunshine passing through the windshield and irradiated to a cabin, so as to effectively reduce the in-vehicle temperature and the adverse effect of the high temperature on automotive trims. During use, the in-vehicle sunshade 10 is paved along a plane of the windshield to prevent sunshine from directly irradiating the cabin.

Referring to FIG. 1 and FIG. 2, the in-vehicle sunshade 10 includes an umbrella handle 100 and foldable ribs 200, where the umbrella handle 100 is configured to support the entire in-vehicle sunshade 10, the foldable ribs 200 are connected to the umbrella handle 100, and each of the ribs 200 is capable of moving along the umbrella handle 100 to switch between a folded state and an unfolded state. In the folded state, each of the ribs 200 is adhered to the umbrella handle 100, the in-vehicle sunshade 10 can be folded, and the folded volume is small, so that it is conveniently folded; and in the unfolded state, the in-vehicle sunshade 10 can be placed on the supporting surface to shield the windshield of the vehicle, so as to prevent sunshine from directly irradiating the cabin.

It shall be noted that in the embodiment, there are 8 ribs 200. In other embodiments, there may be 10 and 12 ribs 200. Therefore, the present disclosure does not limit the number of the ribs 200 specifically.

It shall be noted that the supporting surface can be a plane such as a dashboard panel.

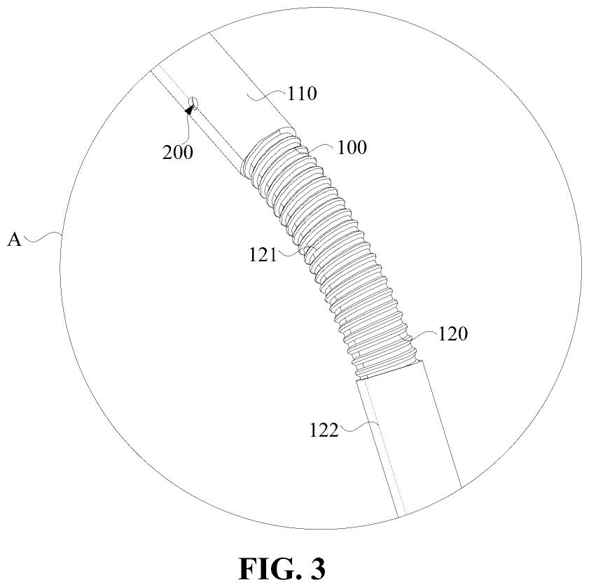

Referring to FIG. 1 and FIG. 3, it shall be noted that the umbrella handle 100 has a mounting end 110 and a handle end 120 opposite to each other in an axial direction thereof, where the handle end 120 is placed on the supporting surface and each of the ribs 200 is connected to the mounting end 110. The handle end 120 is capable of rotating and bending relative to the mounting end 110 to adjust the rotating direction of the handle end 120, so that the user can adjust the placement location of the handle end 120 according to the positions of the automotive trims.

Referring to FIG. 1 and FIG. 2, the in-vehicle sunshade 10 further includes an umbrella fabric 300, where the umbrella fabric 300 is connected to the top of the ribs 200, and the umbrella fabric 300 is capable of being unfolded and spreading along the ribs 200.

To sum up, in the present application, the in-vehicle sunshade 10 includes the umbrella handle 100, the foldable ribs 200, and the umbrella fabric 300, where the umbrella handle 100 has the mounting end 110 and the handle end 120 opposite to each other in an axial direction thereof, the handle end 120 is capable of rotating and bending relative to the mounting end 110 to adjust the direction of the handle end 120; the user can adjust the placement location of the handle end 120 according to positions of the steering wheel and the display in the vehicle. The umbrella handle 100 will not bump against the steering wheel and the display in the vehicle, and the steering wheel and the display will not be damaged, so that the user experience is good.

Referring to FIG. 2 and FIG. 3, the handle end 120 includes a metal hose 121 and a metal rigid tube 122 connected to each other, where the metal hose 121 is connected to the mounting end 110, and the metal hose 121 is capable of driving the metal rigid tube 122 to rotate and bend relative to the mounting end 110 to adjust the placement direction of the metal rigid tube 122. By arranging the metal hose 121, the metal hose 121 is capable of rotating to any position relative to the mounting end 110, so that the handle end 120 will not bump against the steering wheel and the display in the vehicle. It can be understood that the metal hose 121 can also be another type. For example, the metal hose 121 is made of a PVC material. Solutions where the handle end 120 is capable of rotating and bending relative to the mounting end 110 shall be protected.

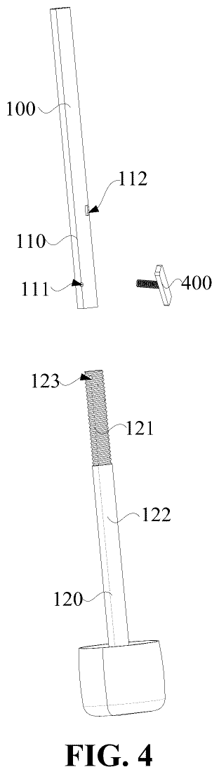

Referring to FIG. 2 and FIG. 4, the in-vehicle sunshade 10 further includes a connector 400, where a first mounting hole 111 is formed in one end of the mounting end 110 close to the metal hose 121, a second mounting hole 123 is formed in one end of the metal hose 121 close to the mounting end 110, the mounting end 110 is sleeved on the outer side of the metal hose 121, and the first mounting hole 111 and the second mounting hole 123 are aligned. In this case, the connector 400 passes through the first mounting hole 111 and the second mounting hole 123 in sequence to mount and fix the mounting end 110 and the metal hose 121. It can be understood that there can be no connector 400 and solutions where the mounting end 110 and the metal hose 121 are capable of being mounted and fixed shall be protected.

It shall be noted that in the embodiment, there are two first mounting holes 111 and second mounting holes 123, and the two first mounting holes 111 are oppositely formed in the radial direction of the mounting end 110; and there are two second mounting holes 123, and the two second mounting holes 123 are oppositely formed in the radial direction of the metal hose 121. The connector 400 needs to pass through the first mounting hole 111 and the second mounting hole 123 on the same side and then pass through the second mounting hole 123 and the first mounting hole 111 on the other side to mount and fix the mounting end 110 and the metal hose 121.

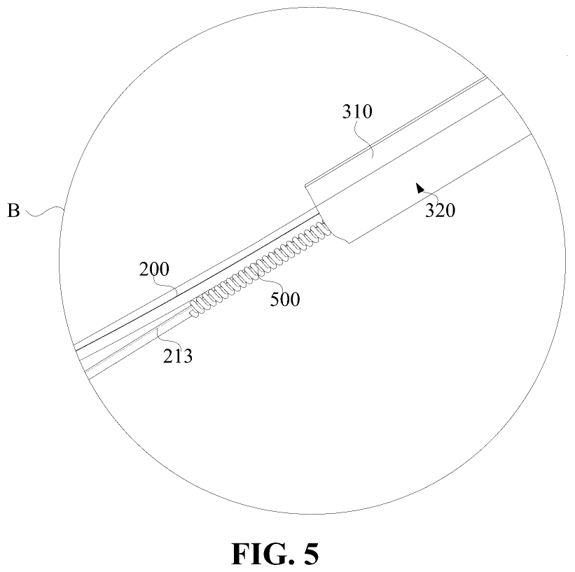

Referring to FIG. 1 and FIG. 5, a plurality of elastically deformable supporting members 310 are arranged at a circumferential edge of the umbrella fabric 300, the number of the supporting members 310 matches the number of the ribs 200, an external end of each of the ribs 200 away from the umbrella handle 100 is in limiting fit with the supporting members 310, and partial structures of the umbrella fabric 300 and the supporting members 310 extend outward relative to the external end. By arranging the elastically deformable supporting members 310, when the in-vehicle sunshade 10 is switched from the folded state to the unfolded state, the supporting members 310 are capable of strutting four corners of the umbrella fabric 300, so that the umbrella fabric 300 completely fits the windshield of the vehicle, and a condition that sunshine is directly irradiated to the cabin as the corner corners of the umbrella fabric 300 cannot fit the windshield is avoided. It can be understood that without considering the condition that the four corners of the umbrella fabric 300 cannot completely fix the windshield, there can be no supporting members 310. Solutions where the umbrella fabric 300 is capable of being operated to open and shielding the windshield shall be protected.

Referring to FIG. 1 and FIG. 5, it shall be noted that the in-vehicle sunshade 10 further includes a plurality of elastic members 500, where the number of the elastic members 500 matches the number of the supporting members 310, the elastic members 500 are sleeved on an outer side of each of the ribs 200, and partial structures of the elastic members 500 are accommodated in the supporting members 310. In the process that the user folds the in-vehicle sunshade 10, the supporting members 310 compress the elastic members 500. The elastic members 500 accumulate elastic forces. When the user unfolds the in-vehicle sunshade 10, the elastic forces of the elastic members 500 are released, so that the supporting members 310 are capable of automatically supporting the four corners of the umbrella fabric 300. It can be understood that there can be no elastic members 500. Solutions where the umbrella fabric 300 is capable of being operated to open and shielding the windshield shall be protected.

Referring to FIG. 1 and FIG. 5, it shall be noted that a limiting hole 320 is formed between each of the supporting members 310 and the umbrella fabric 300, and the external end of each of the ribs 200 is accommodated in the limiting hole 320. Each of the ribs 200 is capable of being fixed with the umbrella fabric 300, and the material is saved. It can be understood that there can also be no limiting hole 320. Solutions where each of the ribs 200 is fixedly connected to the umbrella fabric 300 shall be protected.

It shall be noted that in other embodiments, the supporting members 310 are enclosed to form a limiting hole 320, the external end of each of the ribs 200 is accommodated in the limiting hole 320, and the supporting members 310 are sewed on the umbrella fabric 300.

It shall be noted that in other embodiments, the external end of each of the ribs 200 is in sewing connection to each of the supporting members 310 to mount and fix the ribs 200 and the umbrella fabric 300.

It shall be noted that in other embodiments, a positioning hole is formed in the middle position of the umbrella fabric 300, and one end of the mounting end 110 away from the handle end 120 is mounted in the positioning hole. The mounting end 110 is mounted in the positioning hole, so that the umbrella fabric 300 will not move relative to each of the ribs 200, and the umbrella fabric 300 and the ribs 200 are tightly connected together. It can be understood that there can also be no positioning hole. Solutions where the umbrella fabric 300 is mounted on the ribs 200 shall be protected. It shall be noted that a length direction of the supporting members 310 is parallel to a length direction of the external end of each of the ribs 200.

It shall be noted that in the embodiment, the supporting members 310 are leather sheets.

It shall be noted that in the embodiment, the supporting members 310 are rubber sheets.

It shall be noted that in the embodiment, the supporting members 310 are plastic sheets.

Referring to FIG. 1 and FIG. 2, the in-vehicle sunshade 10 further includes a covering surface 600, where the covering surface 600 is arranged on one side of the umbrella fabric 300 close to the umbrella handle 100. By arranging the covering surface 600, under the circumstance that the umbrella fabric 300 shields sunshine, the covering surface 600 further shields the sun, so that the probability that the sunshine is irradiated to the cabin is further reduced. It can be understood that without considering that the sunshine is further shielded, there can also be no covering surface 600. Solutions where the in-vehicle sunshade 10 includes the umbrella fabric 300 shall be protected.

Referring to FIG. 1 and FIG. 2, it shall be noted that the covering surface 600 and the umbrella fabric 300 both are of quadrilateral structures.

It shall be noted that the area of the covering surface 600 is smaller than the area of the umbrella fabric 300.

It shall be noted that a reflective coating is arranged on one side of the umbrella fabric 300 facing away from the covering surface 600. The reflective coating is capable of effectively reflecting sunshine irradiated to the umbrella fabric 300 and reducing the sunshine irradiated to the cabin.

It shall be noted that an ultraviolet-proof coating is arranged on one side of the covering surface 600 facing towards the umbrella fabric 300. The ultraviolet-proof coating is capable of reducing ultraviolet rays in the sunshine entering the cabin.

Referring to FIG. 1 and FIG. 2, the umbrella fabric 300 is provided with a magic tape 330. The magic tape 330 includes a binding rope 331, a male surface 332 of the magic tape, and a female surface 333 of the magic tape. When the in-vehicle sunshade 10 is in the folded state, the binding rope 331 winds the ribs 200 a circle. The male surface 332 of the magic tape is adhered to the female surface 333 of the magic tape, so that the in-vehicle sunshade 10 is folded conveniently. When the user does not use the in-vehicle sunshade 10, the in-vehicle sunshade 10 wound by the magic tape 330 will not be dispersed. It can be understood that without considering that the in-vehicle sunshade 10 may be dispersed automatically, there can also be no magic tape 330. Solutions where the in-vehicle sunshade 10 is capable of being switched between the unfolded state and the folded state shall be protected.

Referring to FIG. 1 and FIG. 2, the umbrella fabric 300 is provided with a folding space 340. When the user folds the in-vehicle sunshade 10, the umbrella fabrics 300 at both ends of the folding space 340 are close to each other, so that the umbrella fabric 300 in the folded state is smooth, and the aesthetic measure of the in-vehicle sunshade 10 in the folded state is improved. It can be understood that without considering that the umbrella fabric 300 is smooth, there can also be no folding space 340. Solutions where the in-vehicle sunshade 10 is capable of being folded shall be protected.

Referring to FIG. 4, the mounting end 110 is provided with a locking hole 112; each of the ribs 200 includes a support rod assembly 210 and a locking structure 220; the locking structure 220 is sleeved on the umbrella handle 100 and is slidably connected to the umbrella handle 100; the locking structure 220 is capable of moving relative to the mounting end 110 until the locking structure is clamped in the locking hole 112; and one end of the support rod assembly 210 is rotationally connected to the end of the mounting end 110 away from the handle end 120 and the other end of the support rod assembly is rotationally connected to the locking structure 220.

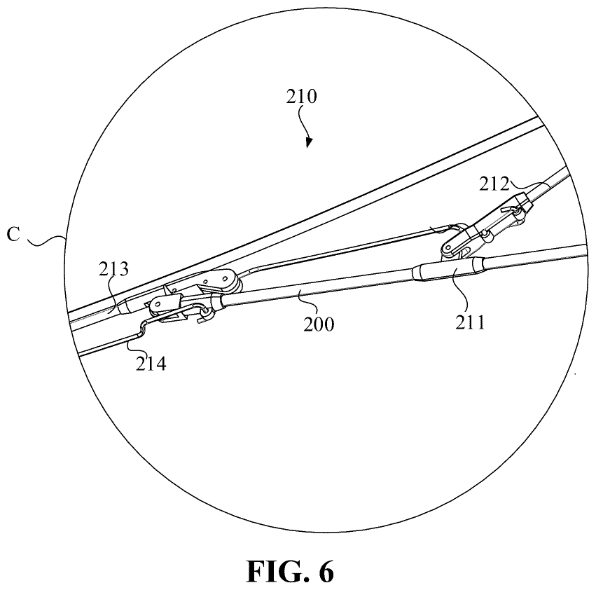

Referring to FIG. 1 and FIG. 6, the support rod assembly 210 includes a first support rod 211, a second support rod 212, a third support rod 213, and a tightening strip 214; two opposite ends of the first support rod 211 are respectively connected to the locking structure 220 and the third support rod 213, two opposite ends of the second support rod 212 are respectively connected to the first support rod 211 and the end of the mounting end 110 away from the handle end 120 and two opposite ends of the tightening strip 214 are respectively connected to the second support rod 212 and the third support rod 213. When the locking structure 220 moves toward the end of the mounting end 110 away from the handle end 120, it drives the first support rod 211 and the second support rod 212 to draw close to gradually support the second support rod 212 until the second support rod is opened. Moreover, the third support rod 213 is also opened under the action of the tightening strip 214 to support the entire umbrella fabric 300.

Although the present disclosure has been described with reference to several typical embodiments, it shall be understood that the terms used are illustrative and exemplary terms rather than restrictive terms. As the present disclosure can be implemented specifically in various forms without departing from the spirit or essence of the present disclosure, it should be understood that the embodiments are not limited to any above-mentioned details but shall be explained extensively in the spirit and scope of the attached claims, and therefore, all variations and modifications falling within the claims or equivalent ranges thereof should be covered by the attached claims.

What is claimed is:

1. An in-vehicle sunshade, comprising:
an umbrella handle, having a mounting end and a handle end opposite to each other in an axial direction thereof, wherein the handle end is capable of rotating and bending relative to the mounting end to adjust a direction of the handle end;
foldable ribs, connected to the mounting end of the umbrella handle; and
an umbrella fabric, connected to a top of the ribs and capable of being folded and spreading with the ribs;
wherein
a plurality of elastically deformable supporting members are arranged at a circumferential edge of the umbrella fabric, the in-vehicle sunshade further comprises a plurality of elastic members, each elastic member is sleeved on an outer surface of one corresponding rib, and partial structures of each elastic member are accommodated in one corresponding supporting member.

2. The in-vehicle sunshade according to claim 1, wherein the handle end comprises a metal hose and a metal rigid tube connected to each other, the metal hose is connected to the mounting end, and the metal hose drives the metal rigid tube to rotate relative to the mounting end.

3. The in-vehicle sunshade according to claim 2, further comprising a connector, at least one first mounting hole is formed in one end of the mounting end adjacent to the metal hose, at least one second mounting hole is formed in one end of the metal hose adjacent to the mounting end, and the connector passes through the at least one first mounting hole and the at least one second mounting hole.

4. The in-vehicle sunshade according to claim 3, wherein the at least one first mounting hole comprises two first mounting holes, and the two first mounting holes are formed oppositely in a radial direction of the mounting end; and the at least one second mounting hole comprises two second mounting holes, and the two second mounting holes are formed oppositely in a radial direction of the metal hose.

5. The in-vehicle sunshade according to claim 1, wherein an external end of each of the ribs away from the umbrella handle is in limiting fit with one corresponding supporting member, and partial structures of the umbrella fabric and the corresponding supporting member extend outward relative to the external end.

6. (canceled)

7. The in-vehicle sunshade according to claim 5, wherein a length direction of the supporting members is parallel to a length direction of the external end of each of the ribs.

8. The in-vehicle sunshade according to claim 5, wherein a limiting hole is formed between each of the supporting members and the umbrella fabric, and the external end of the rib is accommodated in the limiting hole.

9. The in-vehicle sunshade according to claim 5, wherein the supporting members are enclosed to form a limiting hole, and the external end of each of the ribs is accommodated in the limiting hole.

10. The in-vehicle sunshade according to claim 5, wherein the external end of each of the ribs is in sewing connection to each of the supporting members.

11. The in-vehicle sunshade according to claim 5, wherein the supporting members are leather sheets; or,
the supporting members are rubber sheets; or
the supporting members are plastic sheets.

12. The in-vehicle sunshade according to claim 1, further comprising a covering surface, wherein the covering surface is arranged on one side of the umbrella fabric facing the umbrella handle, and an area of the covering surface is smaller than an area of the umbrella fabric.

13. The in-vehicle sunshade according to claim 12, wherein a reflective coating is arranged on one side of the umbrella fabric facing away from the covering surface, and an ultraviolet-proof coating is arranged on one side of the covering surface facing towards the umbrella fabric.

14. The in-vehicle sunshade according to claim 12, wherein the covering surface and the umbrella fabric both are of quadrilateral structures.

15. The in-vehicle sunshade according to claim 1, wherein the umbrella fabric is provided with a hook-and-loop fastener for fixing the umbrella fabric when the in-vehicle sunshade is in a stored state.

16. The in-vehicle sunshade according to claim 15, wherein the hook-and-loop fastener comprises a binding rope, a fastener male surface and a fastener female surface, the fastener male surface is configured to be adhered to the fastener female surface; the binding rope is provided at a side of the notch.

17. (canceled)

18. The in-vehicle sunshade according to claim 1, wherein a positioning hole is formed in a middle position of the umbrella fabric, and one end of the mounting end away from the handle end is mounted in the positioning hole.

19. The in-vehicle sunshade according to claim 1, further comprising a locking structure, wherein the mounting end is provided with a locking hole; each of the ribs comprises a support rod assembly; and one end of the support rod assembly is rotationally connected to the end of the mounting end away from the handle end, and the other end of the support rod assembly is rotationally connected to the locking structure.

20. The in-vehicle sunshade according to claim 19, wherein the support rod assembly comprises a first support rod, a second support rod, a third support rod, and a tightening strip; one end of the first support rod is rotationally connected to the locking structure and the other end of the first support rod is connected to the third support rod; and two opposite ends of the second support rod are respectively connected to the first support rod and the end of the mounting end away from the handle end and two opposite ends of the tightening strip are respectively connected to the second support rod and the third support rod.

21. (canceled)

22. The in-vehicle sunshade according to claim 20, wherein each elastic member is sleeved on an outer surface of the third support rod.

23. The in-vehicle sunshade according to claim 1, wherein when the in-vehicle sunshade is folded, the supporting members compress the elastic members, the elastic members accumulate elastic forces; when the in-vehicle sunshade is unfolded, the elastic forces of the elastic members are released, such that the supporting members are capable of automatically supporting corners of the umbrella fabric.
